(19) United States
(12) Patent Application Publication
(10) Pub. No.: US 2022/0099175 A1
(43) Pub. Date: Mar. 31, 2022

(54) SEALING SYSTEM, GEAR BOX WITH SEALING SYSTEM AND A GAS TURBINE ENGINE WITH SEALING SYSTEM

(71) Applicant: Rolls-Royce Deutschland Ltd & Co KG, Blankenfelde-Mahlow (DE)

(72) Inventors: Thomas PROBERT, Berlin (DE); Jakob VIOLET, Nuthetal (DE)

(21) Appl. No.: 17/410,448

(22) Filed: Aug. 24, 2021

(30) Foreign Application Priority Data
Aug. 28, 2020 (DE) 102020122601.2

(51) Int. Cl. F16H 57/04; F16H 57/029; F02C 7/36

(52) U.S. Cl. CPC F16H 57/0421; F02C 7/36; F16H 57/029

(57) ABSTRACT

The invention relates to a planetary gear box having at least one seal system, which has at least one rectangular-section sealing ring, which is arranged in a groove device, wherein the at least one rectangular-section sealing ring rests at least partially against a groove flank of the groove device, and the groove flank has profiling between the groove flank and the rectangular-section sealing ring for the purpose of distributing fluid, in particular oil, applied to the seal system, wherein the at least one seal system is part of an oil supply of a planet carrier and the seal system has at least two rectangular-section sealing rings, which are spaced apart axially from one another and are arranged radially between a drive shaft of the planetary gear box and the planet carrier. The invention also relates to a gas turbine engine.

This application claims priority to German Application No. 10 2020 122 601.2 filed Aug. 28, 2020, which application is incorporated by reference herein.

The present disclosure relates to a planetary gear box having the features of Claim 11 and to a gas turbine engine having the features of Claim 12.

In mechanical systems, in this case especially planetary gear boxes, it is often necessary to seal off from one another at least two spaces under different pressures and containing different media. Examples of this task are the separation of different operating fluids, the separation of different medium states, the prevention of foreign body ingress or the avoidance of lubricant losses.

It is known in principle that seal systems, e.g. piston or shaft seals, use rectangular-section sealing rings (e.g. US 2002/0145259 A1, U.S. Pat. No. 3,759,148 A, KR. 10-0991990 B1, KR 10-0774733 B1, FVA Research Project No. 471/l Hochdruck-Wellendichtung [High-Pressure Shaft Seal], Meffert et al., Einfluss von statischen und dynamischen Lageabweichungen auf die Leckage eines Dichtsystems mit Rechteckdichtringen [Effect of Static and Dynamic Position Deviations on Leakage in a Sealing System Comprising Rectangular-Section Sealing Rings], Forsch. Ingenieurwes, 2020).

Rectangular-section sealing rings are arranged in a groove device and form a seal both at the peripheral outer surface (i.e. on the side radially opposite the groove base) and at a groove flank.

In this case, there may be function-related leakage during operation, something that may under certain circumstances be desired for the lubrication of the contact surface of the rectangular-section sealing ring. During operation, there may well be relative movements between the rectangular-section sealing ring and the connection components on the groove flank. The peripheral outer surface of the rectangular-section sealing ring is held on the hole surface by friction, which may be reinforced by a negative design allowance of the rectangular-section sealing ring and/or by the applied fluid pressure.

In this case, the rectangular-section sealing ring with the groove device can be arranged in a rotating shaft. The reverse arrangement with the rectangular-section sealing ring in a stationary groove is also possible.

In the case of a piston-ring application, the rectangular-section sealing ring has a speed relative to the liner wall, and therefore there may be mixed friction.

In the case of mixed friction, this leads to wear on the surface of the rectangular-section sealing ring since this generally involves the softer material. As a consequence, the equilibrium of loads on the rectangular-section sealing ring also deteriorates over time. It may also lead to damage, e.g. due to the ingress of dirt particles. This is disadvantageous particularly in the case of sliding over a liquid film.

All this has an effect on the service life of the rectangular-section sealing ring. It is therefore necessary to machine both flanks of the rectangular-section sealing rings in order, for example, to create lubricating pockets. This leads to higher costs in the case of a component which must be exchanged at regular intervals. Machining both edges to avoid incorrect assembly is common.

Planetary gear boxes which are used, for example, in a gas turbine engine of an aircraft must operate without maintenance for a very long time, and therefore it is the object to provide efficient, robust and low-cost planetary gear boxes.

According to a first aspect, the planetary gear box has at least one seal system having at least one rectangular-section sealing ring, which is arranged in a groove device, wherein the at least one rectangular-section sealing ring rests at least partially against a groove flank of the groove device. In this case, the groove flank has profiling between the groove flank and the rectangular-section sealing ring for the purpose of distributing a fluid (e.g. oil) applied to the seal system. By means of the profiling, it is possible selectively to build up a fluid pressure, in particular an oil pressure, which builds up an equilibrium of forces across the rectangular-section sealing ring. In this case, the profiling can be produced in a simple manner and is robust with respect to wear. In the case of the profiling, it is possible to distinguish between two general physical principles. In the case of hydrostatically acting structures, a counter pressure is built up in the region of the contact surface by the applied fluid, reducing the load on the sealing ring and thus reducing wear, for example, since the ring is subject to less severe loads. In the case of hydrodynamically acting structures, a fluid film forms between the ring and the groove, significantly reducing wear. Moreover, the at least one seal system of the planetary gear box is part of an oil supply of a planet carrier, and the seal system has at least two rectangular-section sealing rings, which are spaced apart axially from one another and are arranged radially between a drive shaft of the planetary gear box and the planet carrier. Efficient and robust lubrication of the planetary gear box is thereby possible.

In one embodiment, the profiling is designed as a lubricating pocket, e.g. for lubricating oil.

Depending on the sealing task, the groove device for the rectangular-section sealing ring can be arranged in a static part or a rotationally moved part.

In one embodiment of the seal system, there is hydrodynamic or hydrostatic formation of an equilibrium of forces across the rectangular-section sealing ring, in particular by a hydrodynamic or hydrostatic design of the lubricating pocket.

The good wear properties are obtained, in particular, from the fact that the material of the groove flank is of relatively harder design than the rectangular-section sealing ring.

In one embodiment, the groove device has a groove with a rectangular cross section having a width between 1.5 and 10 mm, in particular between 5 and 10 mm, and a depth between 1 and 10 mm, in particular between 5 and 10 mm. The groove device can also have a diameter between 50 and 500 mm, in particular 300 and 500 mm, at the radial base.

The groove device can be of integral design. In one embodiment, however, it can also be composed of two parts, wherein the groove flank is, in particular, part of a disc or of a flange ring. This makes the seal system easy to produce.

Embodiments of the seal system can be arranged in a gear box or at a shaft feed-through since it is necessary here to manage sealing tasks involving relatively high pressure differences and high mechanical loads, for example.

In this case, the at least one rectangular-section sealing ring can be produced from plastic, for example, in particular a polyimide or polyether ether ketone and/or metal, and/or comprises these materials. Thus, for example, composite materials are also possible as seal materials.

However, it is also possible for the gear box having at least one seal system to be arranged in a wind turbine or a motor vehicle.

The object is also achieved by a gas turbine engine having the features of Claim 12.

As noted elsewhere herein, the present disclosure may relate to a gas turbine engine, for example an aircraft engine. Such a gas turbine engine may comprise a core engine comprising a turbine, a combustor, a compressor, and a core shaft connecting the turbine to the compressor. Such a gas turbine engine may comprise a fan (with fan blades) which is positioned upstream of the core engine.

Arrangements of the present disclosure may be advantageous in particular, but not exclusively, for geared fans, which are driven via a gear box. Accordingly, the gas turbine engine may comprise a gear box which is driven via the core shaft and the output of which drives the fan in such a way that it has a lower rotational speed than the core shaft. The input to the gear box may be effected directly from the core shaft, or indirectly via the core shaft, for example via a spur shaft and/or a spur gear. The core shaft may be rigidly connected to the turbine and the compressor, such that the turbine and compressor rotate at the same rotational speed (with the fan rotating at a lower rotational speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The core engine may furthermore comprise a second turbine, a second compressor, and a second core shaft connecting the second turbine to the second compressor. The second turbine, second compressor and second core shaft may be arranged so as to rotate at a higher rotational speed than the first core shaft.

In such an arrangement, the second compressor may be positioned axially downstream of the first compressor. The second compressor may be arranged to receive (for example directly receive, for example via a generally annular duct) a flow from the first compressor.

The gear box may be designed to be driven by the core shaft that is configured to rotate (for example during use) at the lowest rotational speed (for example the first core shaft in the example above). For example, the gear box may be designed to be driven only by the core shaft that is configured to rotate (for example during use) at the lowest rotational speed (for example only by the first core shaft and not the second core shaft, in the example above). Alternatively, the gear box may be designed to be driven by one or more shafts, for example the first and/or second shaft in the example above.

In a gas turbine engine as described and/or claimed herein, a combustor may be provided axially downstream of the fan and compressor (or compressors). For example, the combustor may be directly downstream of (for example at the exit of) the second compressor, when a second compressor is provided. By way of further example, the flow at the exit of the compressor may be supplied to the inlet of the second turbine, if a second turbine is provided. The combustor may be provided upstream of the turbine(s).

The or each compressor (for example the first compressor and the second compressor as described above) may comprise any number of stages, for example multiple stages. Each stage may comprise a row of rotor blades and a row of stator blades, which may be variable stator blades (i.e. the angle of attack may be variable). The row of rotor blades and the row of stator blades may be axially offset with respect to one another.

The or each turbine (for example the first turbine and the second turbine as described above) may comprise any number of stages, for example multiple stages. Each stage may comprise a row of rotor blades and a row of stator blades. The row of rotor blades and the row of stator blades may be axially offset with respect to one another.

Each fan blade may have a radial span extending from a root (or a hub) at a radially inner location over which gas flows, or from a position of 0% span, to a tip with a 100% span. The ratio of the radius of the fan blade at the hub to the radius of the fan blade at the tip may be less than (or of the order of) any of the following: 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip may be in an inclusive range bounded by two values in the previous sentence (i.e. the values may form upper or lower bounds). These ratios may be referred to in general as the hub-to-tip ratio. The radius at the hub and the radius at the tip may both be measured at the leading edge (or the axially forwardmost edge) of the blade. The hub-to-tip ratio refers, of course, to that portion of the fan blade over which gas flows, i.e. the portion radially outside any platform.

The radius of the fan may be measured between the engine centerline and the tip of the fan blade at its leading edge. The diameter of the fan (which can generally be double the radius of the fan) may be larger than (or of the order of): 250 cm (approximately 100 inches), 260 cm (approximately 103 inches), 270 cm (approximately 105 inches), 280 cm (approximately 110 inches), 290 cm (approximately 115 inches), 300 cm (approximately 120 inches), 310 cm (approximately 123 inches), 320 cm (approximately 125 inches), 330 cm (approximately 130 inches), 340 cm (approximately 135 inches), 350 cm (approximately 139 inches), 360 cm (approximately 140 inches), 370 cm (approximately 145 inches), 380 cm (approximately 150 inches) or 390 cm (approximately 155 inches). The fan diameter may be in an inclusive range bounded by any two of the values in the previous sentence (i.e. the values may form upper or lower bounds).

The rotational speed of the fan may vary in operation. Generally, the rotational speed is lower for fans with a larger diameter. Purely as a non-limiting example, the rotational speed of the fan under cruise conditions may be less than 2500 rpm, for example less than 2300 rpm. Purely by way of a further non-limiting example, the rotational speed of the fan under cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of a further non-limiting example, the rotational speed of the fan under cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

During the use of the gas turbine engine, the fan (with associated fan blades) rotates about an axis of rotation. This rotation results in the tip of the fan blade moving with a speed Uₜᵢₚ. The work done by the fan blades on the flow results in an enthalpy rise dH of the flow. A fan tip loading may be defined as dH/Uₜᵢₚ², where dH is the enthalpy rise (for example the average 1-D enthalpy rise) across the fan and Uₜᵢₚ is the (translational) speed of the fan tip, for example at the leading edge of the tip (which may be defined as fan tip radius at the leading edge multiplied by angular speed). The fan tip loading at cruise conditions may be more than (or of the order of): 0.3, 0.31, 0.32, 0.33, 0.34, 0.35, 0.36, 0.37, 0.38, 0.39, or 0.4 (wherein all units in this passage are Jkg⁻¹K⁻¹/(ms⁻¹)²). The fan tip loading may be in an inclusive range bounded by any two of the values in the previous sentence (i.e. the values may form upper or lower bounds).

Gas turbine engines in accordance with the present disclosure can have any desired bypass ratio, wherein the bypass ratio is defined as the ratio of the mass flow rate of the flow through the bypass duct to the mass flow rate of the flow through the core at cruise conditions. In the case of some arrangements, the bypass ratio can be more than (or of the order of): 10, 10.5, 11, 11.5, 12, 12.5, 13, 13.5, 14, 14.5, 15, 15.5, 16, 16.5, or 17. The bypass ratio may be in an inclusive range bounded by any two of the values in the previous sentence (i.e. the values may form upper or lower bounds). The bypass duct may be substantially annular. The bypass duct may be radially outside the core engine. The radially outer surface of the bypass duct may be defined by an engine nacelle and/or a fan casing.

The overall pressure ratio of a gas turbine engine as described and/or claimed herein may be defined as the ratio of the stagnation pressure upstream of the fan to the stagnation pressure at the exit of the highest pressure compressor (before entry into the combustor). As a non-limiting example, the overall pressure ratio of a gas turbine engine as described and/or claimed herein at cruising speed may be greater than (or of the order of): 35, 40, 45, 50, 55, 60, 65, 70, 75. The overall pressure ratio may be in an inclusive range bounded by any two of the values in the previous sentence (i.e. the values may form upper or lower bounds).

The specific thrust of an engine can be defined as the net thrust of the engine divided by the total mass flow through the engine. The specific thrust of an engine as described and/or claimed herein at cruise conditions may be less than (or of the order of): 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in an inclusive range bounded by any two of the values in the previous sentence (i.e. the values may form upper or lower bounds). Such engines can be particularly efficient in comparison with conventional gas turbine engines.

A gas turbine engine as described and/or claimed herein may have any desired maximum thrust. Purely as a non-limiting example, a gas turbine as described and/or claimed herein may be capable of generating a maximum thrust of at least (or of the order of): 160 kN, 170 kN, 180 kN, 190 kN, 200 kN, 250 kN, 300 kN, 350 kN, 400 kN, 450 kN, 500 kN or 550 kN. The maximum thrust may be in an inclusive range bounded by any two of the values in the previous sentence (i.e. the values may form upper or lower bounds). The thrust referred to above may be the maximum net thrust under standard atmospheric conditions at sea level plus 15° C. (ambient pressure 101.3 kPa, temperature 30° C.), with the engine static.

During use, the temperature of the flow at the entry to the high-pressure turbine can be particularly high. This temperature, which may be referred to as TET, may be measured at the exit to the combustor, for example immediately upstream of the first turbine blade, which itself may be referred to as a nozzle guide blade. At cruising speed, the TET may be at least (or of the order of): 1400 K, 1450 K, 1500 K, 1550 K, 1600 K or 1650 K. The TET at cruising speed may be in an inclusive range bounded by any two of the values in the previous sentence (i.e. the values may form upper or lower bounds). The maximum TET in the use of the engine may be at least (or of the order of), for example: 1700 K, 1750 K, 1800 K, 1850 K, 1900 K, 1950 K or 2000 K. The maximum TET may be in an inclusive range bounded by any two of the values in the previous sentence (i.e. the values may form upper or lower bounds). The maximum TET may occur, for example, under a high thrust condition, for example under a maximum take-off thrust (MTO) condition.

A fan blade and/or airfoil portion of a fan blade described and/or claimed herein may be produced from any suitable material or combination of materials. For example, at least a part of the fan blade and/or airfoil may be produced at least in part from a composite, for example a metal matrix composite and/or an organic matrix composite, such as carbon fiber. As a further example, at least a part of the fan blade and/or airfoil may be produced at least in part from a metal, such as a titanium-based metal or an aluminum-based material (such as an aluminum-lithium alloy) or a steel-based material. The fan blade may comprise at least two regions produced using different materials. For example, the fan blade may have a protective leading edge, which is produced using a material that is better able to resist impact (for example from birds, ice or other material) than the rest of the blade. Such a leading edge may, for example, be produced using titanium or a titanium-based alloy. Thus, purely by way of example, the fan blade may have a carbon-fiber or aluminium-based body (such as an aluminium-lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture device which may engage with a corresponding slot in the hub (or disk). Purely as an example, such a fixture may be in the form of a dovetail that may slot into and/or be brought into engagement with a corresponding slot in the hub/disk in order to fix the fan blade to the hub/disk. As a further example, the fan blades may be formed integrally with a central portion. Such an arrangement may be referred to as a blisk or a bling. Any suitable method may be used to manufacture such a blisk or such a bling. For example, at least some of the fan blades may be machined from a block and/or at least some of the fan blades may be attached to the hub/disk by welding, such as e.g. linear friction welding.

The gas turbine engines described and/or claimed herein may or may not be provided with a variable area nozzle (VAN). Such a variable area nozzle may allow the exit area of the bypass duct to be varied during operation. The general principles of the present disclosure can apply to engines with or without a VAN.

The fan of a gas turbine as described and/or claimed herein may have any desired number of fan blades, for example 16, 18, 20, or 22 fan blades.

As used herein, cruise conditions may mean the cruise conditions of an aircraft to which the gas turbine engine is attached. Such cruise conditions can be conventionally defined as the conditions at mid-cruise, for example the conditions experienced by the aircraft and/or the engine between (in terms of time and/or distance) the top of climb and the start of descent.

Purely by way of example, the forward speed at the cruise condition can be any point in the range of from Mach 0.7 to 0.9, for example 0.75 to 0.85, for example 0.76 to 0.84, for example 0.77 to 0.83, for example 0.78 to 0.82, for example 0.79 to 0.81, for example of the order of Mach 0.8, of the order of Mach 0.85 or in the range of from 0.8 to 0.85. Any arbitrary speed within these ranges can be the constant cruise condition. In the case of some aircraft, the constant cruise conditions may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example of the order of 11000 m. The cruise conditions may correspond to standard atmospheric conditions at any given altitude in these ranges.

Purely as an example, the cruise conditions may correspond to the following: a forward Mach number of 0.8, a pressure of 23000 Pa and a temperature of −55° C.

As used anywhere herein, “cruising speed” or “cruise conditions” may mean the aerodynamic design point. Such an aerodynamic design point (or ADP) may correspond to the conditions (comprising, for example, the Mach number, environmental conditions and thrust demand) for which the fan is designed to operate. This may mean, for example, the conditions at which the fan (or gas turbine engine) is designed to have optimum efficiency.

During operation, a gas turbine engine described and/or claimed herein may be operated under the cruise conditions defined elsewhere herein. Such cruise conditions may be determined by the cruise conditions (for example the conditions during the middle part of the flight) of an aircraft on which at least one (for example two or four) gas turbine engine(s) may be mounted in order to provide propulsive thrust.

It is self-evident to a person skilled in the art that a feature or parameter described in relation to one of the above aspects may be applied to any other aspect, unless these are mutually exclusive. Furthermore, any feature or any parameter described here may be applied to any aspect and/or combined with any other feature or parameter described here, unless these are mutually exclusive.

Embodiments will now be described by way of example, with reference to the figures, in which:

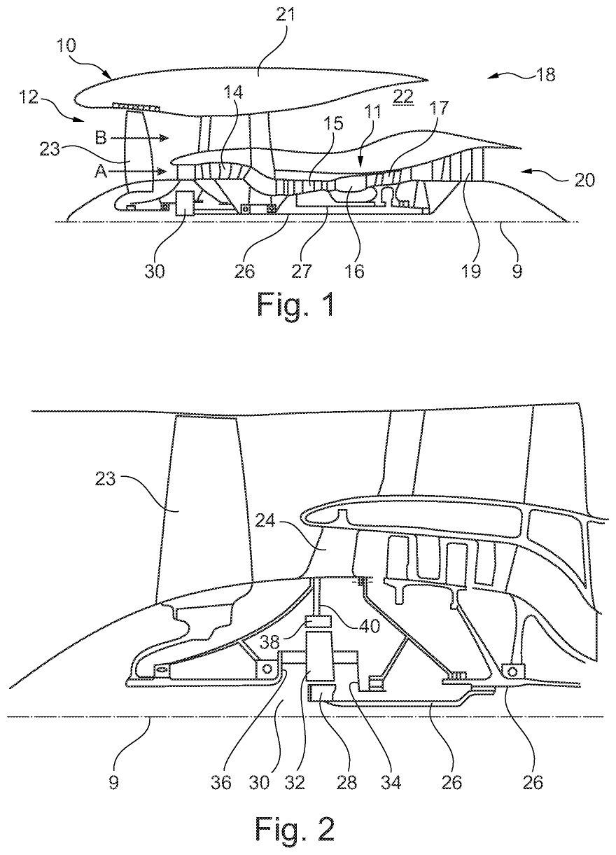

FIG. 1 shows a sectional side view of a gas turbine engine having one embodiment of a planetary gear box;

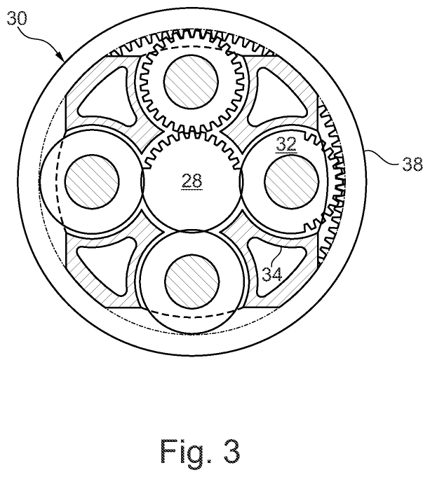

FIG. 2 shows a close-up sectional side view of an upstream portion of a gas turbine engine;

FIG. 3 shows a partially cut-away view of a gear box for a gas turbine engine;

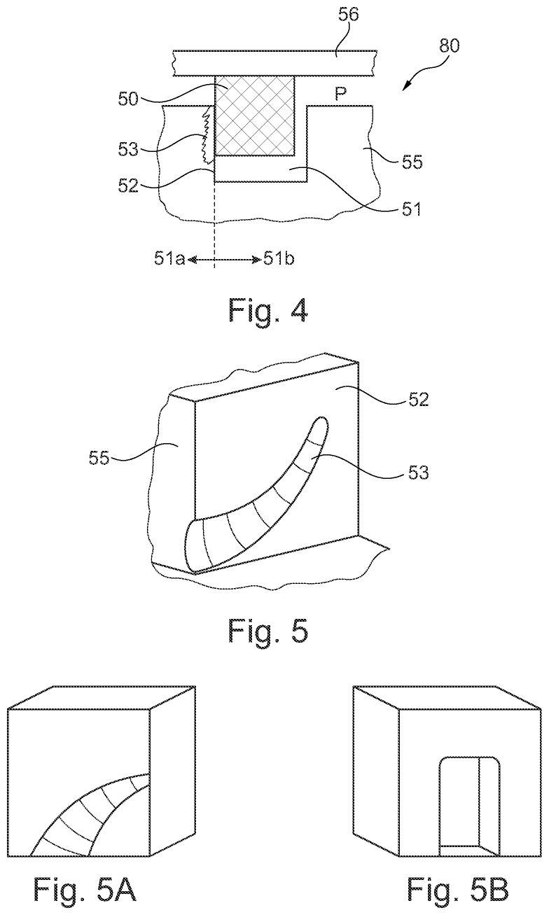

FIG. 4 shows a sectional view through a seal system which can be used in one embodiment of a planet gear;

FIG. 5 shows a perspective view of a groove flank of an embodiment of a seal system;

FIG. 5A shows a perspective view of a groove flank an alternative embodiment of a seal system;

FIG. 5B shows a perspective view of a groove flank an alternative embodiment of a seal system;

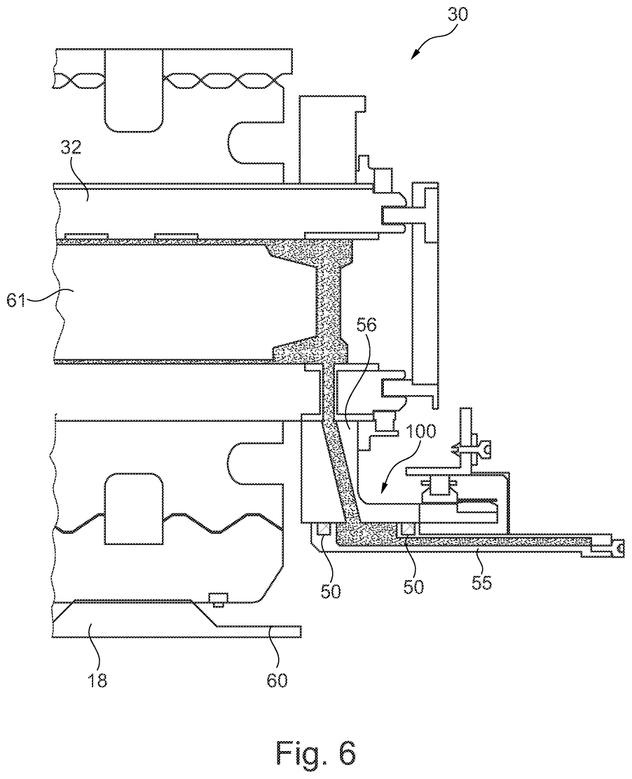

FIG. 6 shows a sectional view through part of one embodiment of a planetary gear box having a seal system.

Before embodiments and details of a planetary gear box 30 having a seal system 100 are described (see FIG. 6), an area of application, namely a gas turbine engine 10 of an aircraft, will be described in conjunction with FIGS. 1 to 3. In FIGS. 4 and 5, details of profiling for oil distribution in the seal system 100 are then described, it being possible to use said details in embodiments of the planetary gear box 30.

FIG. 1 illustrates a gas turbine engine 10 having a main axis of rotation 9. The engine 10 comprises an air intake 12 and a fan 23 that generates two air flows: a core air flow A and a bypass air flow B. The gas turbine engine 10 comprises a core 11 that receives the core air flow A. When viewed in the order corresponding to the axial direction of flow, the core engine 11 comprises a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low-pressure turbine 19 via a shaft 26 and an epicyclic planetary gear box 30.

During operation, the core air flow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resulting hot combustion products then propagate through the high-pressure and the low-pressure turbines 17, 19 and thereby drive said turbines, before being expelled through the nozzle 20 to provide a certain propulsive thrust. The high-pressure turbine 17 drives the high-pressure compressor 15 by means of a suitable connecting shaft 27. The fan 23 generally provides the major part of the propulsive thrust. The epicyclic planetary gear box 30 is a reduction gear box.

An exemplary arrangement for a geared fan gas turbine engine 10 is shown in FIG. 2. The low-pressure turbine 19 (see FIG. 1) drives the shaft 26, which is coupled to a sun gear 28 of the epicyclic planetary gear box 30. Multiple planet gears 32, which are coupled to one another by a planet carrier 34, are situated radially to the outside of the sun gear 28 and mesh therewith. The planet carrier 34 guides the planet gears 32 in such a way that they circulate synchronously around the sun gear 28, whilst enabling each planet gear 32 to rotate about its own axis. The planet carrier 34 is coupled via linkages 36 to the fan 23 in order to drive its rotation about the engine axis 9. Radially to the outside of the planet gears 32 and meshing therewith is an annulus or ring gear 38 that is coupled, via linkages 40, to a stationary support structure 24.

It should be noted that the expressions “low-pressure turbine” and “low-pressure compressor”, as used herein, can be taken to mean the lowest-pressure turbine stage and lowest-pressure compressor stage (i.e. not including the fan 23), respectively, and/or the turbine and compressor stages that are connected together by the connecting shaft 26 with the lowest rotational speed in the engine (i.e. not including the gear box output shaft that drives the fan 23). In some documents, the “low-pressure turbine” and the “low-pressure compressor” referred to herein may alternatively be known as the “intermediate-pressure turbine” and “intermediate-pressure compressor”. Where such alternative nomenclature is used, the fan 23 can be referred to as a first, or lowest-pressure, compression stage.

The epicyclic planetary gear box 30 is shown by way of example in greater detail in FIG. 3. The sun gear 28, planet gears 32 and ring gear 38 in each case comprise teeth on their periphery to allow intermeshing with the other gearwheels. However, for clarity, only exemplary portions of the teeth are illustrated in FIG. 3. Although four planet gears 32 are illustrated, it will be apparent to the person skilled in the art that more or fewer planet gears 32 may be provided within the scope of protection of the claimed invention. Practical applications of an epicyclic planetary gear box 30 generally comprise at least three planet gears 32.

The epicyclic planetary gear box 30 illustrated by way of example in FIGS. 2 and 3 is a planetary gear box in which the planet carrier 34 is coupled to an output shaft via linkages 36, with the ring gear 38 being fixed. However, any other suitable type of planetary gear box 30 may be used. As a further example, the planetary gear box 30 may be a star arrangement, in which the planet carrier 34 is held fixed, with the ring gear (or external gear) 38 allowed to rotate. In such an arrangement, the fan 23 is driven by the ring gear 38. As a further alternative example, the gear box 30 can be a differential gear box in which both the ring gear 38 and the planet carrier 34 are allowed to rotate.

It will be appreciated that the arrangement shown in FIGS. 2 and 3 is by way of example only, and various alternatives are within the scope of protection of the present disclosure. Purely by way of example, any suitable arrangement can be used for positioning the gear box 30 in the engine 10 and/or for connecting the gear box 30 to the engine 10. By way of a further example, the connections (such as the linkages 36, 40 in the example of FIG. 2) between the gear box 30 and other parts of the engine 10 (such as the input shaft 26, the output shaft and the fixed structure 24) may have a certain degree of stiffness or flexibility. As a further example, any suitable arrangement of the bearings between rotating and stationary parts of the engine 10 (for example between the input and output shafts of the gear box and the fixed structures, such as the gear casing) may be used, and the disclosure is not limited to the exemplary arrangement of FIG. 2. For example, where the gear box 30 has a star arrangement (described above), a person skilled in the art would readily understand that the arrangement of output and supporting linkages and bearing positions would usually be different from that shown by way of example in FIG. 2.

Accordingly, the present disclosure extends to a gas turbine engine having any arrangement of gear box types (for example star or epicyclic-planetary), supporting structures, input and output shaft arrangement, and bearing positions.

Optionally, the gear box may drive additional and/or alternative components (for example the intermediate-pressure compressor and/or a booster compressor).

Other gas turbine engines in which the present disclosure can be used may have alternative configurations. For example, such engines may have an alternative number of compressors and/or turbines and/or an alternative number of connecting shafts. As a further example, the gas turbine engine shown in FIG. 1 has a split flow nozzle 20, 22, which means that the flow through the bypass duct 22 has a dedicated nozzle, which is separate from the engine core nozzle 20 and is radially on the outside with respect to the latter. However, this is not restrictive, and any aspect of the present disclosure can also apply to engines in which the flow through the bypass duct 22 and the flow through the core 11 are mixed or combined before (or upstream of) a single nozzle, which may be referred to as a mixed flow nozzle. One or both nozzles (whether mixed or split flow) can have a fixed or variable area. Whilst the described example relates to a turbofan engine, the disclosure may be applied, for example, to any type of gas turbine engine, such as an open-rotor (in which the fan stage is not surrounded by an engine nacelle) or turboprop engine, for example. In some arrangements, the gas turbine engine 10 may not comprise a gear box 30.

The geometry of the gas turbine engine 10, and components thereof, is/are defined by a conventional axis system, comprising an axial direction (which is aligned with the axis of rotation 9), a radial direction (in the bottom-to-top direction in FIG. 1), and a circumferential direction (perpendicular to the view in FIG. 1). The axial, radial and circumferential directions run so as to be mutually perpendicular.

At various points in the planetary gear box 30, it may be necessary to provide seal systems 100, as will be shown in conjunction with FIG. 6.

First of all, however, details of one configuration of a seal system 100 will be given. FIG. 4 illustrates a sectional view through part of a seal system 100, the intention here being to provide sealing between a static part 55 and a rotating part 56 against a relatively high oil pressure p on the right-hand side.

For this purpose, a rectangular-section sealing ring 50 is arranged in a groove device 51 of the static part 55. Here, the groove device 51 is formed substantially in a U shape in the static part 55, wherein the rectangular-section sealing ring 50 does not completely fill the groove device 51. In this arrangement, one side of the rectangular-section sealing ring 50 is subject to the oil pressure p which fills the groove device 51.

One side—here the right-hand side—of the rectangular-section sealing ring 50 is subject to the oil pressure p, which is relatively high in comparison with the left-hand side and which pushes the rectangular-section sealing ring 50 to the left against a groove flank 52. Between the base of the groove device 51 and the inside of the rectangular-section sealing ring 50, the oil pressure p can exert a radially outward pressing action on the rectangular-section sealing ring 50. The outside of the rectangular-section sealing ring 50 is thereby pressed in a sealing manner against the inside of the rotating part 56.

In the case of the profiling, it is possible to distinguish fundamentally between two general physical principles. In the case of hydrostatically acting structures, a counter pressure is built up in the region of the contact surface by the applied fluid, reducing the load on the sealing ring and thus reducing wear, for example, since the ring is subject to less severe loads. In the case of hydrodynamically acting structures, a fluid film forms between the ring and the groove, significantly reducing wear.

Arranged in the groove flank 52 is profiling 53 for the purpose of distributing oil, and this profiling will be described in greater detail below. Here, the profiling 53 is designed as a lubricating pocket, for example, as illustrated schematically in FIG. 5. By virtue of the profiling 53, the oil pressure p can also take effect from the side of the groove flank 52, leading to an improved equilibrium of pressure across the rectangular-section sealing ring 50. By reducing the loads, a reduction in wear or abrasion is achieved.

Thus, it is not necessary to arrange such lubricating pockets in the rectangular-section sealing ring 50 itself, which would be expensive and these pockets could also be damaged by abrasion, for example.

If the sealing device 100 is produced integrally from a single component, the profiling 53 can be introduced into the groove flank 52 by a laser method, for example.

Another possibility for the construction is also illustrated in FIG. 4. The static part 55 can be composed of two parts, for example. In this case, a first part (here on the left) of the groove device 51a can be designed as a disc, for example, with the result that the groove flank 52 (and the profiling 53) would occupy an annular region on the disc. A disc 51a of this kind could easily be machined in order to introduce profiling 53.

A second part (here on the right) of the groove device 51b can then be designed as a shaft part with an offset. When the parts 51a, 51b are assembled, the substantially U-shaped construction of the groove device 51 is obtained.

For typical applications, such as those which are illustrated in conjunction with FIG. 6, the groove device 51 has a groove of rectangular cross section with a width between 5 and 10 mm and a depth between 5 and 10 mm. The groove device 51 can likewise have a diameter between 300 and 500 mm at the radial base.

In this case, the rectangular-section sealing ring 50 can be produced from plastic, for example, in particular a polyimide or a polyether ether ketone and/or metal (e.g. cast materials), or can comprise these materials. In this case, the material of the groove flank 52 will generally be harder than the material of the rectangular-section sealing ring 51.

By means of such a configuration, relative speeds at the sealing surface of 20 to 60 m/s can be achieved and pressure differences of 10 to 30 bar can be sealed off.

FIG. 6 illustrates an application of a seal system 100 in a planetary gear box 30 of the kind that can be used in a gas turbine engine 10 (see FIGS. 1 to 3), for example.

In this case, the sun gear 28 and a journal 61 of a planet gear 32 are illustrated here. The planet gear 32 can rotate around the journal 61, wherein this mounting of the planet gear 32 must be lubricated.

Here, the sun gear 28 of the planetary gear box 30 is driven via a drive shaft 60. An oil supply is illustrated radially outside the drive shaft 60, wherein oil is fed in under pressure from the right through the channels indicated in black from the region of the casing of the gas turbine engine 10.

The seal system 100 used here has two axially mutually spaced rectangular-section sealing rings 50 in the static part 55 in the oil feed. Here, sealing is performed with respect to the rotating part 56 of the planet carrier 34. The groove devices 51 in which the rectangular-section sealing rings 50 are arranged have groove flanks 52 with profiling 53 corresponding to the embodiment shown in FIG. 4. However, it is also possible in principle for the seal system 100 to provide sealing between a drive shaft of the planetary gear box 30 and the planet carrier 34. It is also possible for more than two axially mutually spaced rectangular-section sealing rings 50 to be used.

This shows that the seal system 100 can also have more than one rectangular-section sealing ring 50.

Seal systems of the type described here can also be used for other sealing tasks, e.g. in internal combustion engines or wind turbines. Moreover, the seal systems 100 have here been described in conjunction with oil, which is used as a lubricant. In principle, it is also possible to use seal systems 100 of this kind for sealing with respect to other fluids.

It will be understood that the invention is not limited to the embodiments described above, and various modifications and improvements can be made without departing from the concepts described herein. Any of the features may be used separately or in combination with any other features, unless they are mutually exclusive, and the disclosure extends to and includes all combinations and subcombinations of one or more features which are described here.

### LIST OF REFERENCE SIGNS

9 Main axis of rotation
10 Gas turbine engine
11 Core engine
12 Air inlet
14 Low-pressure compressor
15 High-pressure compressor
16 Combustion device
17 High-pressure turbine
18 Bypass thrust nozzle
19 Low-pressure turbine
20 Core thrust nozzle
21 Engine nacelle
22 Bypass channel
23 Fan
24 Stationary supporting structure
26 Shaft
27 Connecting shaft
28 Sun gear
30 Gear box, planetary gear box
32 Planet gears
34 Planet carrier
36 Linkage
38 Ring gear
40 Linkage
50 Rectangular-section sealing ring
51 Groove device
51a First part of the groove device
51b Second part of the groove device
52 Groove flank
53 Profiling in groove flank
55 Static part of the seal system
56 Rotating part of the seal system
60 Drive shaft
61 Journal for planet gear
100 Seal system
A Core air flow
B Bypass air flow
p Oil pressure

1. A planetary gear box having at least one seal system, which has at least one rectangular-section sealing ring, which is arranged in a groove device, wherein the at least one rectangular-section sealing ring rests at least partially against a groove flank of the groove device,
and the groove flank has profiling between the groove flank and the rectangular-section sealing ring for the purpose of distributing fluid, in particular oil, applied to the seal system, wherein the at least one seal system is part of an oil supply of a planet carrier and the seal system has at least two rectangular-section sealing rings, which are spaced apart axially from one another and are arranged radially between a drive shaft of the planetary gear box and the planet carrier.

2. The planetary gear box according to claim 1, wherein the profiling is designed as a lubricating pocket.

3. The planetary gear box according to claim 1, wherein the groove device is arranged in a static part or a rotationally moved part.

4. The planetary gear box according to claim 1, wherein a hydrodynamic or hydrostatic design of an equilibrium of forces across the rectangular-section sealing ring, in particular by a hydrodynamic or hydrostatic design of the lubricating pocket.

5. The planetary gear box according to claim 1, wherein the material of the groove flank is of relatively harder design than the rectangular-section sealing ring.

6. The planetary gear box according to claim 1, wherein the groove device has a groove with a rectangular cross section having a width between 1.5 and 10 mm, in particular between 5 and 10 mm, and a depth between 1 and 10 mm, in particular between 5 and 10 mm.

7. The planetary gear box according to claim 1, wherein the groove device has a diameter between 50 and 500 mm, in particular between 300 and 500 mm, at the radial base.

8. The planetary gear box according to claim 1, wherein the groove device is composed of two parts, wherein the groove flank is, in particular, part of a disc or of a flange ring.

9. The planetary gear box according to claim 1, wherein it is arranged in a gear box or at a shaft feed-through.

10. The planetary gear box according to claim 1, wherein the at least one rectangular-section sealing ring is produced from plastic, in particular a polyimide or polyether ether ketone and/or metal, or comprises these materials.

11. The planetary gear box according to claim 1, wherein said gear box is arranged in a wind turbine or a motor vehicle.

12. (canceled)

13. (canceled)

14. (canceled)

15. (canceled)

16. A gas turbine engine for an aircraft, said gas turbine engine comprising the following:
a core engine comprising a turbine, a compressor, and a core shaft connecting the turbine to the compressor;
a fan, which is positioned upstream of the core engine, wherein the fan comprises a plurality of fan blades; and
a planetary gear box, according to claim 1, which can be driven by the core shaft, wherein the fan can be driven by means of the planetary gear box at a lower speed than the core shaft.
